(19) United States
(12) Patent Application Publication
(10) Pub. No.: US 2005/0254341 A1
(43) Pub. Date: Nov. 17, 2005

(54) Food and drink blender

(76) Inventors: Christian A. Gerling, Federal Way, WA (US); Christopher Todd Schuler, Tacoma, WA (US)

Correspondence Address: Mark S. Peloquin;PELOQUIN, PLLC, Suite 4100, 800 Fifth Avenue, Seattle, WA, 98104-3100, US

(21) Appl. No.: 10/847,487

(22) Filed: May 17, 2004

(51) Int. Cl. A47J 43/046

(52) U.S. Cl. 366/205; 366/314

(57) ABSTRACT

An apparatus includes a knife and a cupped structure. The cupped structure has a top edge and the knife is rotatably coupled with the cupped structure. The knife is positioned mostly within the cupped structure and mostly below the top edge. The top edge is configured for use with a blender, such that when the cupped structure is mated with the blender, food contents can be cut by the knife. A portable source of power is mate-able with the apparatus to rotate the knife.

### BACKGROUND OF THE INVENTION

1. Field of Invention

The invention relates generally to food and drink blenders, and more specifically to apparatuses and methods used to provide a portable blender for field use.

2. Art Background

Devices designed to reduce mixtures of solid foods, liquids, and powders to the consistency of a thick liquid such as a slurry or a semi-frozen mass are known in the art as blenders. One such device is used in various places, such as a bar, a restaurant or a kiosk to make frozen alcoholic drinks such as a frozen margarita. Another drink made with such a device is known as a smoothie. The device accepts a quantity of food such as frozen fruit, frozen berries, frozen vegetables, juice, powder, ice, alcohol, etc. and reduces the contents through blending, grinding and/or cutting with a knife to the consistency of a thick liquid or a semi-frozen mass. The knife used in such a device is sharp and can easily cut a user's finger unless extreme care is used when handling the blender. The blenders used in restaurants and kiosks (commercial blenders) are powered by alternating current, available from standard building power receptacles. Commercial blenders typically require power at either 120 or 240 volts AC. Commercial blenders are heavy and are not designed for portable field use.

Subsequent to the blending step, the food contents within the blender bottle are poured into a drinking glass for consumption by a user. The commercial blender's requirements of alternating current and a separate drinking glass along with its heavy weight do not make the blender suitable for portable field use such as on a camping trip, a boat trip, a hunting trip, a beach party, etc.

Smaller blenders are available for home use (home blenders) and are similar in design to the commercial blenders described above. The home blenders are configured to be powered by alternating current, available from standard wall outlets. Standard wall outlets supply power, typically at a nominal value of 110-120 volts AC. Like the commercial blenders, the home blenders are heavy, not portable, require a separate drinking glass, and they are not field operable from a source of power such as a battery, this may present a problem.

Home blenders, like commercial blenders, have a sharp knife or knives that cut the food contents, such as the frozen fruit, berries, ice, etc., described above, into small pieces to produce the thick liquid or semi-frozen mass. After use, the blender requires cleaning. Home blenders are disassembled, typically by unscrewing a base portion that contains the knife or knives. The knives are exposed, they can come loose and can easily come into contact with a user during handling resulting in harmful cuts to the user's fingers and or hand, this may present a problem.

Thus, existing blenders present a hazard to the user during cleaning, are not portable, require a separate drinking glass, and are not operable in field conditions; all of these characteristics may present a problem.

### BRIEF DESCRIPTION OF THE DRAWINGS

The invention may best be understood by referring to the following description and accompanying drawings that are used to illustrate embodiments of the invention. The invention is illustrated by way of example in the embodiments and is not limited in the figures of the accompanying drawings, in which, like references indicate similar elements. In the drawings:

FIG. 1 illustrates, in one embodiment, a cross sectional view of a blender container;

FIG. 2 illustrates a portable blender with an insulated bottle, according to one embodiment of the invention;

FIG. 3 illustrates another cross sectional view of a blender bottle according to one embodiment of the invention;

FIG. 4 illustrates a blender bottle configured for advertising according to one embodiment of the invention;

FIG. 5 depicts a football shaped blender bottle according to one embodiment of the invention;

FIG. 6 illustrates a flat base according to one embodiment of the invention;

FIG. 7 illustrates a golf ball shaped blender bottle according to one embodiment of the invention;

FIG. 8 illustrates a beaker shaped blender bottle according to embodiments of the invention;

FIG. 9 illustrates grips according to embodiments of the invention; and

FIG. 10 shows a handle according to one embodiment of the invention.

### DETAILED DESCRIPTION

In the following detailed description of embodiments of the invention, reference is made to the accompanying drawings, in which like references indicate similar elements, and in which is shown by way of illustration, specific embodiments in which the invention may be practiced. These embodiments are described in sufficient detail to enable those of ordinary skill in the art to practice the invention. In other instances, well-known circuits, structures, and techniques have not been shown in detail in order not to obscure the understanding of this description. The following detailed description is, therefore, not to be taken in a limiting sense, and the scope of the invention is defined only by the appended claims.

Apparatuses and methods are disclosed to provide a portable blender that enables a user to safely make blended drinks without the need for household alternating current (nominally supplied at 120 volts). In one or more embodiments, an integrated blender bottle/container keeps the food contents cold by providing insulation. In one or more embodiments, the integrated blender bottle/container is made to resemble an object, such as a football in one example. In one or more embodiments, the integrated blender bottle/blender can be used as an advertisement.

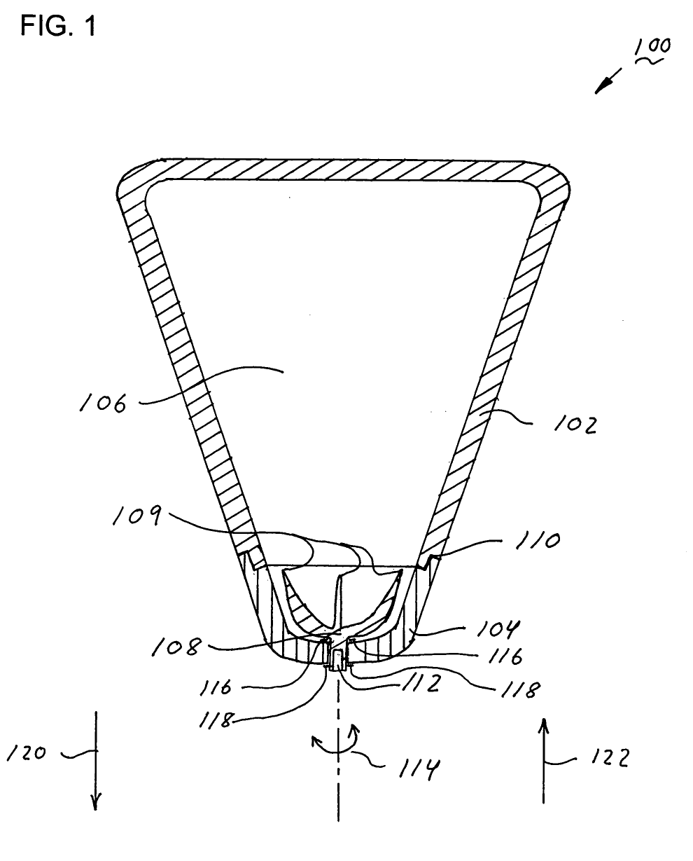

FIG. 1 illustrates, in one embodiment, a cross sectional view of a blender container. With reference to FIG. 1, a cross sectional view of a blender container is shown generally at 100. As used in this description of embodiments of the invention, the terms “blender bottle,” “bottle” or “container” are understood to be used synonymously when referring to the device used to hold the food contents for blending. In like manner, the term “food contents” is used to refer to any ingredient that a user would blend together to create an edible combination of food ingredients. For example, food contents includes, but is not limited to, ice, berries, fruit, vegetables, alcoholic beverages, alcohol, juice, water, milk, coffee, espresso, etc. Food contents can also exist in the frozen state, for example, frozen berries, ice, etc. No limitation is presented to the type of food contents that a user could place into the blender bottle for blending. Also, as used within this description, blending, grinding, cutting and like terms all refer to the action of the knife on the food contents and are understood to be used interchangeably, herein.

In one embodiment, a blender bottle 102 has an interior volume 106. Food contents (not shown) are placed into the interior volume 106 prior to blending. A cupped section 104 is configured to be releasably couple-able (mate-able) with the blender bottle 102. The cupped section 104 is a cupped structure that can be mated to the blender bottle 102, utilizing any one of a number of techniques known to those of skill in the art, such as a screw thread, an interlocking slot, a friction fit, etc.

A knife 108 is rotatably coupled with the cupped section 104 and the knife 108 need not be secured to the cupped section 104 by coupling together the cupped section 104 and the blender bottle 102. The knife 108 has one or more blades, as shown in FIG. 1. In one embodiment, ends 109 of the knife blades terminate mostly below a top edge 110 of the cupped section 104. In the embodiment shown in FIG. 1, the ends 109 are contained within and below the top edge 110 of the cupped section 104. In other embodiments (not shown) the ends 109 can extend above the top edge 110. The cupped section is designed so that when the cupped section 104 is disassembled from the blender bottle 102, the cupped section 104 can be handled by a user without requiring the user to grasp the knife 108 directly. In one embodiment, the knife 108 is substantially or mostly contained within the cupped section 104. Safe cleaning of the cupped section 104 and the knife 108 is thus facilitated by the design of the cupped section 104 and the placement of the knife 108, therein. If desired, knife 108 can be disassembled from the cupped section 104 for additional cleaning.

In one embodiment, the knife 108 is rotatably coupled to the cupped section 104; such a rotatable coupling can be releasable. To position the knife 108 relative to the cupped section 104, a mechanism 116 limits travel of the knife 108 along the axis 114 in a down direction indicated by an arrow 120. A mechanism 118 limits travel of the knife 108 along axis 114 in an upward direction, indicated by an arrow 122. The mechanism 116 is in various embodiments, a clip, a washer, part of the knife 108, such as a shoulder in a shaft, etc. The mechanism 118 can be a clip, a washer, a nut, a threaded connection in a shaft or coupling 112, etc. to provide location of the knife 108 relative to the cupped section 104. Such connection between the knife 108 and the cupped section 104 permits the knife 108 to remain attached to the cupped section 104 without the knife 108 falling out of the cupped section 104 and then requiring handling by a user. In one embodiment, mechanism 118 is a built-in lip, which is part of the shaft onto which the knife 108 is attached. In one embodiment, the shaft is configured such that it is threaded and can be assembled or separated by screwing or unscrewing the respective pieces. Such disassembly of the respective pieces allows the knife 108 to be removed from the cupped section 104 to facilitate cleaning food particles. In other embodiments, the mechanism 118 can facilitate disassembly of the shaft from the cupped section for cleaning.

The knife 108 is configured to rotate about axis 114, facilitated by a connection with a suitable source of power. Coupling 112 permits a source of power to be connected to the knife 108. Coupling 112 can be any type of coupling such as a coupling utilizing a spline, or a square, hex, octagonal, etc. receptacle or other methods of coupling.

Various sources of power can be connected to the knife 108. In one embodiment, the cupped section can be incorporated into existing commercial or home blenders to provide a cupped section/knife assembly that can be safely cleaned without harming the user. In such an embodiment, the typical source of power is provided by an electric motor designed to operate on household current from a wall outlet at a nominal value of 120 volts. In other embodiments, the knife 108 is rotated by a battery powered motor such as a cordless electric drill.

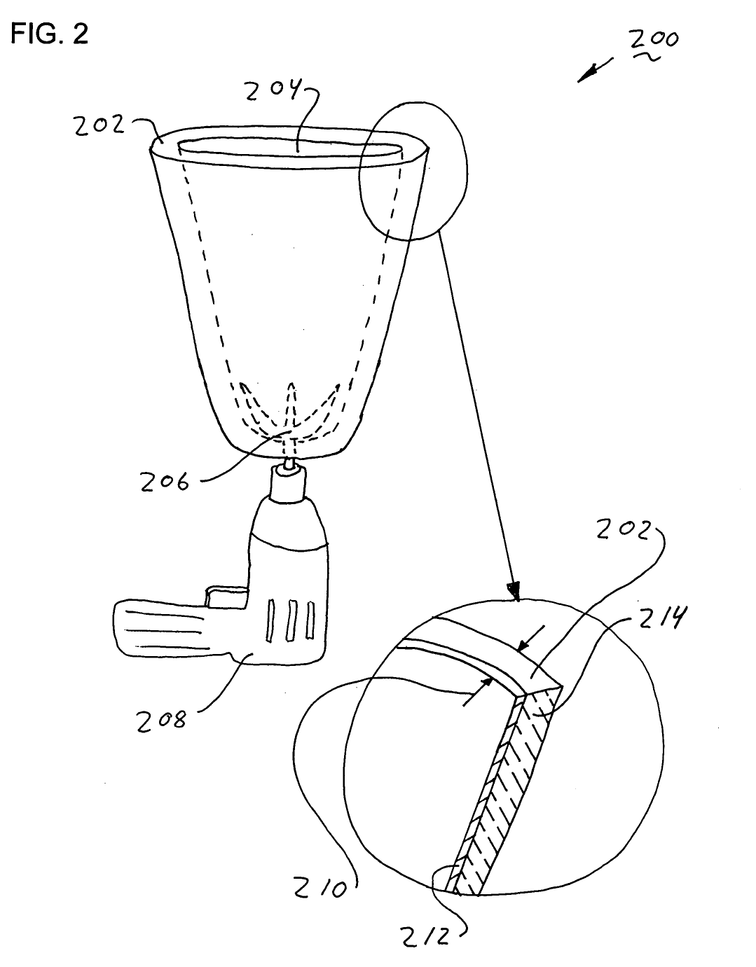

FIG. 2 illustrates a portable blender with an insulated bottle, according to one embodiment of the invention. With reference to FIG. 2, a portable blender is shown generally at 200. A blender bottle 202 has an opening 204 into which the food contents, as previously described, can be placed for blending. A knife 206 is rotatably coupled with the blender bottle 202 to blend the food contents (not shown). A portable source of power 208, rotates the knife 206, blending the food contents thereby. In one embodiment, a portable source of power can be provided from a battery operated electric drill. Such drills are routinely used around the home, boat, job, work site, etc. The portable source of power is not limited to a battery operated electric drill. Various sources of power can be used to rotate knife 206; thereby blending or cutting the food contents. For example, in one embodiment, a battery powered electric motor is provided in a housing (not shown) that rests on a surface, such as a picnic table, counter top, etc. The blender bottle 202 is placed on the housing, coupling the knife 206 with the electric motor to provide the torque necessary to rotate the knife; thereby, blending, grinding, and/or cutting the food contents. A cross-section of the blender bottle 202 is shown in a magnified view within FIG. 2.

The blender bottle 202 has a wall thickness 210. In one embodiment, the wall thickness 210 has a first region 212 and a second region 214. In one embodiment, the first region 212 has a thermal conductivity and a second region 214 has a thermal conductivity that is different from the thermal conductivity of the first region. A difference in thermal conductivities, between the two regions of the wall thickness can be chosen to provide insulation to the food contents (not shown) that are placed in the blender bottle 202. In one embodiment, the first region 212 is made of a structural plastic such as polyethylene or polycarbonate, metal, etc. and the second region 214 is made out of closed-cell foam insulation such as Ensolite® brand foam.

The apparatus can be used to make frozen drinks such as frozen margaritas, frozen smoothies, etc. A frozen drink is typically made with ice or frozen fruit in order to provide the consistency that is desired by consumers of such drinks (users). Often, such drinks are consumed in warm indoor or hot outdoor environments. These environments accelerate warming and ultimately melting of the frozen portion of the drink. Heat is conducted from the environment to the contents of the blender bottle. Enhancing the insulation provided to the contents through an insulated blender bottle wall maintains the frozen food contents in their frozen state for a longer period of time, resulting in an increased time that the drink can be consumed while in the frozen or cool condition.

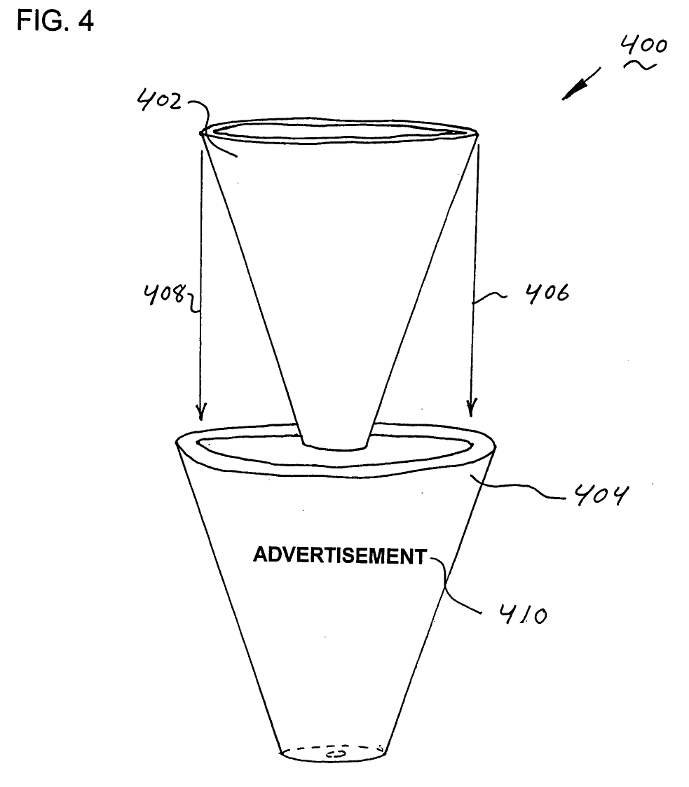

In another embodiment, the two regions 212, and 214 represent a composite construction of the blender bottle, wherein material properties can vary between the regions. For example, the inner region could be a structural material such as plastic or metal and the outer region could be a softer material such a rubber, foam, etc. In other embodiments, one material can be opaque and the other can be transparent or translucent or both materials could be transparent or opaque. Different visual appearances can be created by combinations of material so combined. It may be desirable to create an advertisement out of the portable blender bottle with different material combinations. Such advertisements will be described below in conjunction with FIG. 4.

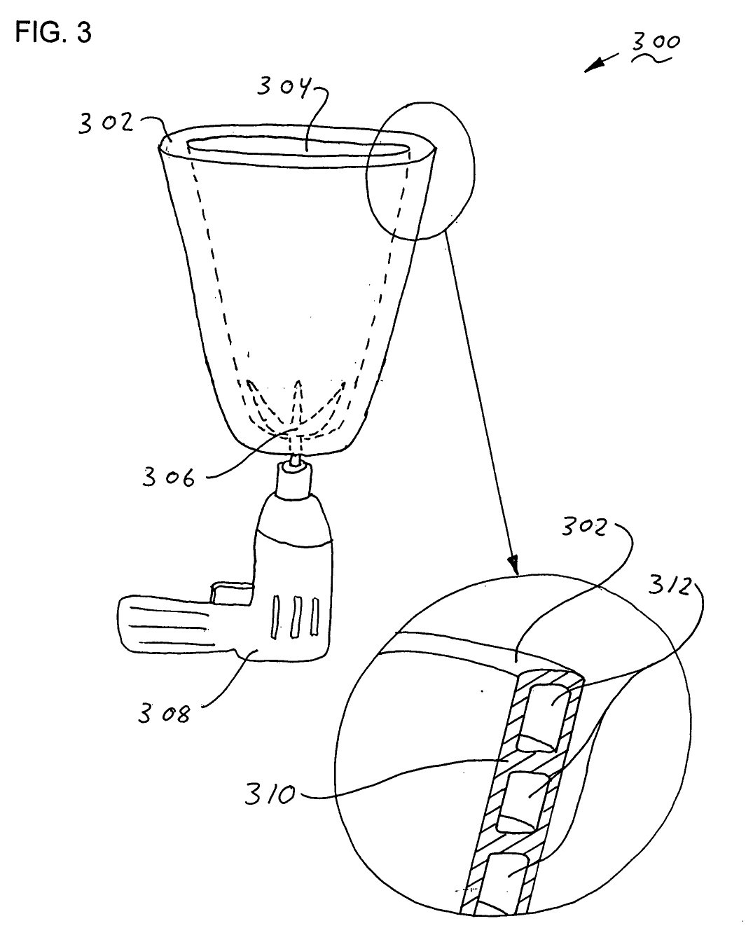

FIG. 3 illustrates another cross-sectional view of a blender bottle according to one embodiment of the invention. With reference to FIG. 3, a portable blender is shown generally at 300. A blender bottle 302 has a knife rotatably coupled therein, such that the food contents can be placed into opening 304 and can be blended, etc. by the knife 306. A source of power 308 provides the torque necessary to rotate the knife 306 and to blend, cut, grind, etc. the food contents (not shown). A cross-sectional view of the blender bottle 302 is shown in the detail view within FIG. 3. In one embodiment, the blender bottle wall thickness 302 includes two regions, a first region at 310, and a second region at 312. In the embodiment shown in FIG. 3, the first region 310 defines a series of voids such as 312. Such a wall thickness encompassing a series of voids provides insulation to the food contents contained within the blender bottle 302.

FIG. 4 illustrates a blender bottle configured for advertising according to one embodiment of the invention. With reference to FIG. 4, a blender bottle adapted for advertising is shown generally at 400. A blender bottle 402 is configured with a knife (not shown), as previously described, such that a source of power can be coupled to the knife. Food contents, placed within the blender bottle can be blended as previously described. The blender bottle wall thickness can be provided in two regions, as previously described. In one embodiment, a first region corresponds to 402 and a second region corresponds to 404. In one embodiment, the two regions can be joined as indicated by the arrows 406 and 408 to form a two layered blender bottle as shown in FIG. 2 at 200. In one embodiment, an advertisement 410 can be placed on the second region 404. The advertisement is visible to a viewer of the blender bottle. In other embodiments, the advertisement can be placed on 402. In order to be visible to a viewer, the second region 404 can be made out of a clear material such as plastic, etc. to facilitate viewing the advertisement, placed on 402, through the second region 404.

Advertisements can be written messages, product logos, etc. An advertisement can advertise a sports team, such as a particular football team, baseball team, hockey team, etc. An advertisement can promote, a charity's cause or the advertisement can promote a business's goods or services. An advertisement can promote a geographic area, such as Florida for example. General advertisements can be placed on the blender bottle; the blender bottle is not limited to the kind of advertisement placed thereon. In one embodiment, the shape of the blender bottle can be chosen to enhance the advertisement value of the blender bottle, for example an orange, a pineapple, etc. or the shape itself can function as an advertisement as defined by a user (i.e., a user defined shape).

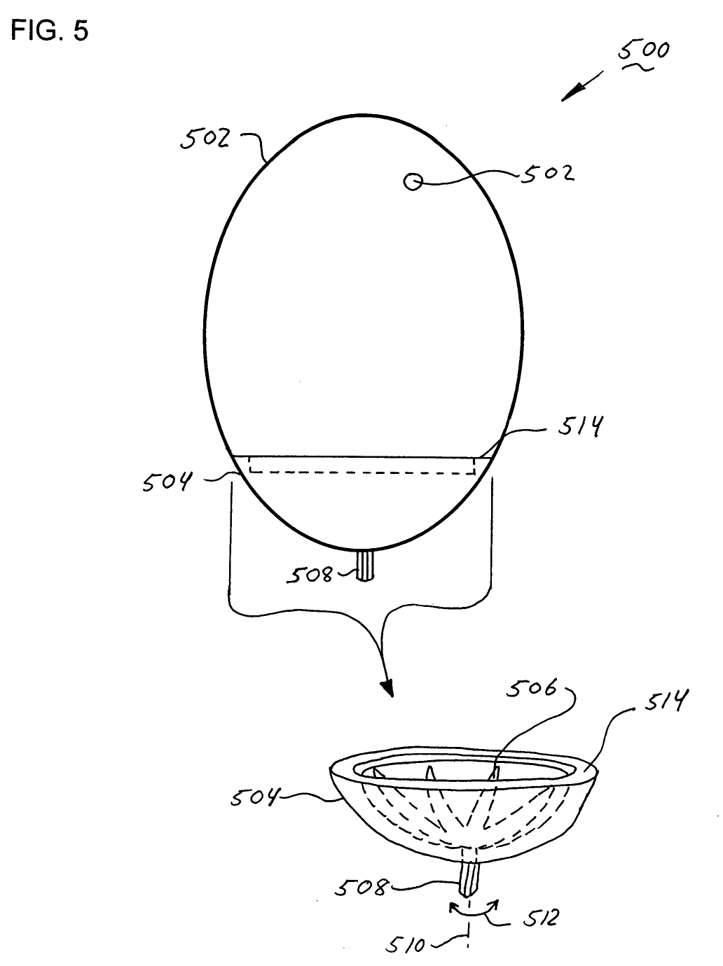

FIG. 5 depicts a football shaped blender bottle according to one embodiment of the invention, shown generally at 500. With reference to FIG. 5, a football shaped blender bottle 502 is releasably couple-able with an end-cap section 504. End-cap section 504 is a cupped structure, and a knife 506, having at least one blade, is rotatably coupled therewith. In the embodiment shown in FIG. 5, the ends of the knife 506 terminate below the surface 514 of the end-cap section 514. In other embodiment (not shown) the ends of the knife 506 can extend beyond surface 514, but not so much as to present an excessive hazard to the user. The end-cap section 504 is designed to substantially enclose or to substantially contain the knife 506; however, in various embodiments, the ends of the knife 506 can extend beyond surface 514 without requiring the user to grasp the knife in order to handle the end-cap section 504 during disassembly of the end-cap section 504 from blender bottle 502. Such a design is within the meaning of the term substantially enclose or substantially contain.

A coupling 508 is provided to allow a source of power to connect with and to rotate the knife 506. The coupling 508 can be any type of coupling used to connect rotating parts with sources of power. Some examples of coupling 508 are, but are not limited to, a keyed shaft, an octagonal shaft, a hex shaft, etc. The present invention is not limited by the type of coupling used to connect a source of power to the knife 506.

A source of power (not shown) is coupled to the knife 506 by coupling 508 to rotate the knife 506 about axis 510 as indicated by arrow 512. In one embodiment, a portable electric powered drill is used to rotate knife 506 to blend, etc. the food contents (not shown); thereby, producing a beverage that can be consumed by a user. A straw (not shown) can be inserted through drinking port 502; thereby, allowing a user to easily consume the food contents.

In one method of operation of the portable blender shown in FIG. 5, the drinking port is plugged, the blender bottle 502 is thus turned upside down, and the end-cap section 504 is removed; thereby, allowing a user to place food contents into the blender bottle. After filling, the blender bottle is rotated back to the orientation shown in FIG. 5 and a portable source of power is coupled thereto, as shown in FIG. 2 and FIG. 3, to rotate the knife and to blend the food contents. Following blending, the blender bottle is typically removed from the source of power so that the user can easily handle the blender bottle while consuming the food contents. In these embodiments, the blender bottle provides the dual function of housing the food contents during blending and serving as a drinking container after blending.

An auxiliary base (not shown) can be provide to facilitate standing the blender bottle up when the blender bottle is shaped in a fashion that is not readily stable, such as with the rounded end football shape shown in FIG. 5.

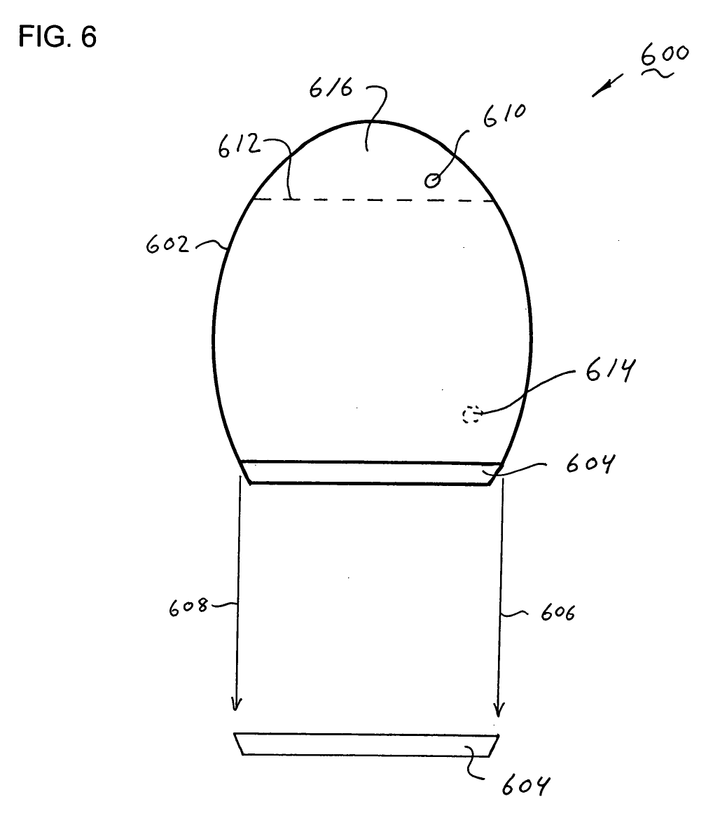

FIG. 6 illustrates a flat base according to one embodiment of the invention, shown generally at 600. With reference to FIG. 6, a blender bottle 602 has a detachable flat base 604. In one embodiment, the flat base 604 can replace the end-cap section 504 (FIG. 5) to provide a flat base on which the blender bottle can rest when the blender bottle is used as a drinking container. The flat base 604 can be detached as indicated by arrows 608 and 606. The flat base 604 can be releasably coupled to the blender bottle 602 via various methods, such as a threaded connection, a twist lock, tapered surface providing a friction fit, etc.

In another embodiment, the blender bottle 602 can be provided with a releasable upper section 616 that separates along a line 612. Another location for a drinking port is 614. In one embodiment, an end-cap section with a knife, such as 504 (FIG. 5) can remain attached to the blender bottle 602 in place of 604. The upper portion 616 is removed from the blender bottle 602 and the flat base 604 is attached at 612. Accordingly, the blender bottle can be turned upside down from the position shown in FIG. 6, and the food contexts can be consumed from the drinking port 614 with a straw (not shown). Alternatively, after blending and while the blender bottle is turned upside down from the position shown in FIG. 6, the end-capped section 504 (FIG. 5) can be removed and the contents can be sipped from the edge of the blender bottle. The blender bottle can be configured into shapes other than the football shown in FIG. 5 and FIG. 6.

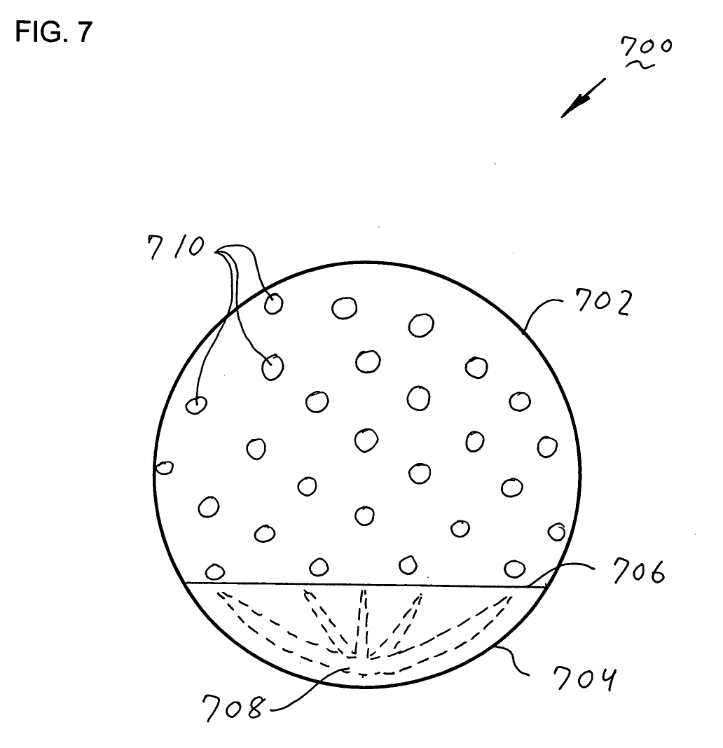

FIG. 7 illustrates a golf ball shaped blender container according to one embodiment of the invention, shown generally at 700. With reference to FIG. 7, a blender container has an upper portion 702 and a lower portion 704. The lower portion 704 is a cupped structure that contains a knife 708, rotatably coupled therewith. The lower portion 704 is releasably couple-able with the upper portion 702 along a mating surface indicated at 706. As previously described in conjunction with the preceding figures, the portions of the blender container can be releasably coupled together utilizing various techniques, such as but not limited to, a threaded connection, an interlocking slot, friction fit, etc.

The lower portion 704 and the upper portion 702 can be separated, thereby allowing food contents to be added to the blender container for blending as described in conjunction with the previous figures. One or more drinking ports (not shown) can be provided to allow a user to drink from the blender container utilizing a device such as a straw, or the user can drink the food contents by sipping from the edge of the upper portion 702 when the lower portion 704 is removed (the upper portion 702 being rotated one hundred eighty degrees from the position shown in FIG. 7).

In one embodiment, a plurality of dimples 710 are incorporated into an outer surface of the upper portion 702 and/or the lower portion 704 to provide a golf ball like appearance. Alternatively, a mottled surface can be provided for 702 and 704 that make the blender container resemble an orange. Such appearances can be used as advertisements or in conjunction with other indicia of advertisement such as logos, text, etc.

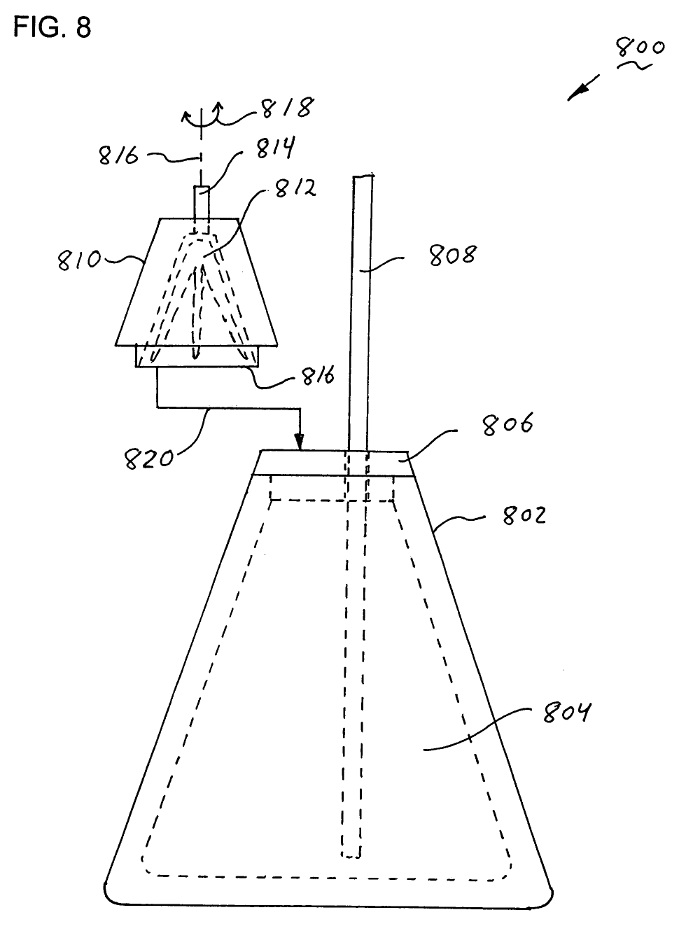

FIG. 8 illustrates a beaker shaped blender bottle according to an embodiment of the invention, shown generally at 800. With reference to FIG. 8, a blender bottle 802 defines an interior volume 804, into which, the food contents can be placed for blending, as previously described. A lid 806 is releasably couple-able with the blender bottle 804. The lid 806 can be provided with a hole into which a drinking device such as a straw 808 can be placed to facilitate drinking by a user.

An end-cap section 810 is a cupped structure that has a knife 812 rotatably coupled thereto. The knife 812 has a coupling 814 to provide connection with a source of power (not shown) to rotate the knife 812 about axis 816, as indicated by arrow 818. The source of power can be, in various embodiments, any of the sources of power previously described. Some examples, of such sources of power are, but are not limited to, electric motors; portable battery operated electric motors, etc.

In the embodiment shown in FIG. 8, the ends of the knife 812 do not extend beyond an edge 816 of the end-cap section 810. In other embodiments (not shown) the ends of the knife 812 can extend beyond the edge 816, but not so much as to cause a user to be cut thereby. The end-cap section 810 substantially encloses or substantially contains the knife 812. The end-cap section 810 is designed so that when the end-cap section 810 is disassembled from the blender bottle 802, the end-cap section 810 can be handled by a user without requiring the user to grasp the knife 812 directly. Safe cleaning of the end-cap section 810 and the knife 812 is thus facilitated by the design of the end-cap section 810 and the placement of the knife 812, therein. If desired, knife 812 can be disassembled from the end-cap section 810 for additional cleaning.

The end-cap section 810 is configured to be releasably couple-able with the blender bottle 802, as indicated by an arrow 820, in place of the lid 806. The end-cap section 810 can be mated to the blender bottle 802 utilizing various techniques as previously described, including but not limited to, screw thread, interlocking slot, friction fit, etc.

According to one method of use, the blender bottle 802 is filled with food contents to be blended, the end-cap section is coupled with the blender bottle, the assembly is rotated one hundred and eighty degrees from the orientation shown in FIG. 8, and power is applied to rotate the knife, blending the food contents thereby. After blending, the assembly is returned to the orientation shown in FIG. 8, the end-cap section 810 is removed and the contents can be consumed by a user in various ways. For example, a user can sip the contents from the edge of the blender bottle 802, or use a drinking device such as the straw 808, or use the lid 808 with a drinking device such as the straw 808.

The beaker shaped blender bottle can be provided with an advertisement fixed in a fashion that is visible to a viewer as previously described in conjunction with the previous figures.

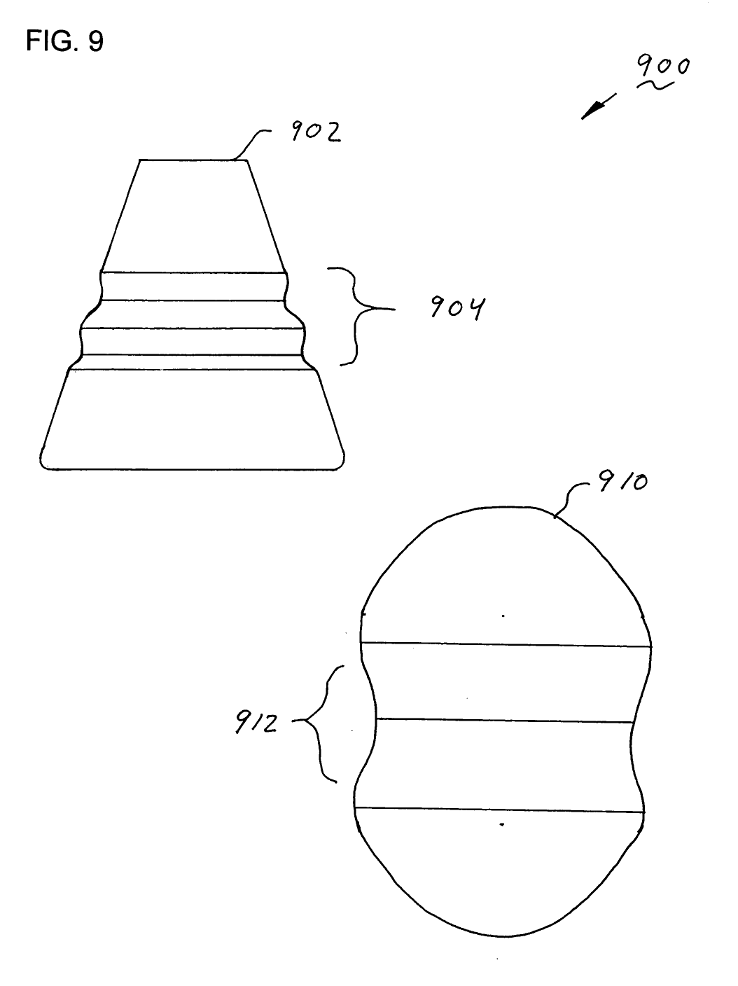

FIG. 9 illustrates grips according to embodiments of the invention, shown generally at 900. With reference to FIG. 9, in one embodiment, a blender bottle in the shape of a beaker having an indentation is depicted at 902. Indentation 904 is formed into the blender bottle 902 to allow a user to grasp the blender bottle 902. Such an indentation facilitates handling the blender bottle by the user. Handling is facilitated by the user, during both the blending phase and the drinking phase of use.

The indentation 904 can extend in a symmetric fashion around the circumference of the blender bottle (as shown in FIG. 9) or the indentation can be incorporated into a blender bottle in a non-symmetric way, such as via a series of indentations positioned to coincide with the contact points of a user's fingers.

In one embodiment, blender bottle 910 is in the shape of a football and contains an indentation 912. Various other types of indentations are possible; the indentations need not be confined to the forms shown in FIG. 9. Indentations can be combined with a surface that inherently supplies friction, such as rubber.

Another form of grip is achieved by utilizing a material that has a high coefficient of friction with respect to contact with a user's hand. One such material is rubber. A rubber surface can be provided to the user in various ways. For example, rubber can be applied to the blender bottle in the form of a coating. Alternatively, in one embodiment, the blender bottle can be manufactured out a composite material, where one layer of the composite is a rubber layer. In another embodiment, a composite layer of friction material or a coating of friction material can be applied to the exterior of the blender bottle over a part of or over the entire exterior surface, providing a grip thereby.

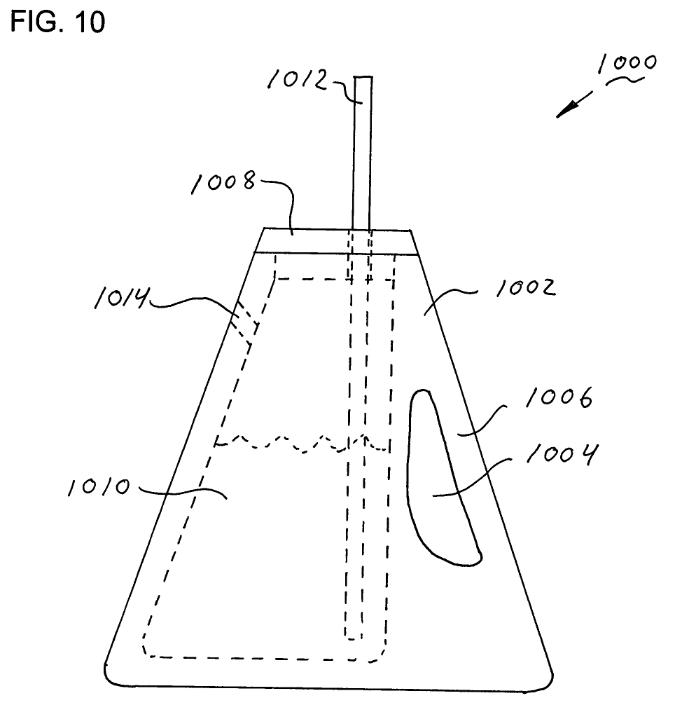

In another embodiment, a grip can be provided by incorporating an appendage (not shown) or a handle (FIG. 10) with the blender bottle. In such an embodiment, a user can grasp the appendage to facilitate handling the blender bottle both during the blending and/or drinking phases of use.

FIG. 10 shows a handle according to one embodiment of the invention, shown generally at 1000. With reference to FIG. 10, a blender bottle 1002 has a first volume 1010 to receive a quantity of food contents for blending as previously described in conjunction with the preceding figures. The blender bottle 1002 contains a second volume that includes a void 1004 sufficient to form a handle 1006 that a user can grasp. In one embodiment, the second volume is configured to prevent the food contents from entering therein.

A lid 1008 can include a hole through which a device for drinking, such as a straw 1012, can be placed to allow the user to consume the food contents. Alternatively, the user can sip the food contents from the opening of the blender bottle 1002. in yet another embodiment, the lid 1008 can be configured with a drinking port through which the user can sip the food contents.

In one embodiment, an end-cap section can be coupled with the blender bottle 1002 in place of the lid 1008 to facilitate blending the food contents. In one embodiment, the end-cap section 810 (FIG. 8) can be coupled with the blender bottle 1002 to blend the food contents and then be removed for drinking. In another embodiment, the end-cap section 810 (FIG. 8) can be left on the blender bottle 1002 after blending and a drinking port 1014 can be provided to allow the user to consume the food contents without removing the end-cap section 810 from the blender bottle 1002.

For purposes of discussing and understanding the embodiments of the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

While the invention has been described in terms of several embodiments, those of skill in the art will recognize that the invention is not limited to the embodiments described, but can be practiced with modification and alteration within the spirit and scope of the appended claims. The description is thus to be regarded as illustrative instead of limiting.

1. An apparatus comprising:
a knife; and
a cupped structure, the cupped structure having a top edge, the knife rotatably coupled with the cupped structure, wherein the knife is positioned mostly within the cupped structure and mostly below the top edge, the top edge is configured for use with a blender, such that when the cupped structure is mated with the blender, food contents can be cut by the knife.

2. The apparatus of claim 1, further comprising:
a blender bottle, the blender bottle is configured to be mated with the cupped structure to form a container that can hold the food contents.

3. The apparatus of claim 1, wherein the knife is configured to be coupled with a source of power that rotates the knife.

4. The apparatus of claim 3, wherein the source of power is provided by a device selected from the group consisting of a battery powered electric drill, an electric drill and an electric motor.

5. The apparatus of claim 2, wherein the blender bottle has a wall thickness, the wall thickness further comprising:
a first region having a first thermal conductivity; and
a second region having a second thermal conductivity.

6. The apparatus of claim 5, wherein the first region and the second region define a void.

7. The apparatus of claim 5 wherein at least one of the first region and the second region is an insulation layer.

8. The apparatus of claim 5, further comprising:
an advertisement attached to the blender bottle and visible to a viewer.

9. The apparatus of claim 8, wherein the advertisement is selected from the group consisting of a sports team advertisement, a charity advertisement, a business advertisement, an advertisement for a geographic area, an advertisement promoting a cause and a general advertisement.

10. The apparatus of claim 2, wherein a shape of the container is selected from the group consisting of a cone, a beaker, a football, a golf ball and a user defined shape.

11. The apparatus of claim 2, further comprising:
a drinking lid, the drinking lid is configured to mate with the blender bottle and to facilitate drinking by a user.

12. The apparatus of claim 2, the blender bottle further comprising:
a grip to facilitate grasping the blender bottle.

13. The apparatus of claim 12, wherein the grip is selected from the group consisting of an indentation, a friction layer, an appendage and a handle.

14. The apparatus of claim 2, the blender bottle further comprising:
a first volume, the first volume configured to receive the food contents and to be couple-able with the knife; and
a second volume, the second volume is configured to contain a handle, wherein the food contents are contained within the first volume and the food contents do not enter into the second volume.

15. An apparatus comprising:
a knife; and
a cupped structure, the cupped structure having a top edge, the knife rotatably coupled with the cupped structure, the top edge is configured for use with a blender, such that when the cupped structure is mated with the blender, food contents can be cut by the knife.

16. The apparatus of claim 15, further comprising:
a blender bottle, the blender bottle is configured to be mated with the cupped structure to form a container that can hold the food contents.

17. The apparatus of claim 15, wherein the knife is releasably coupled to the cupped structure.

18. The apparatus of claim 15, wherein the knife is configured to be coupled with a source of power that rotates the knife.

19. The apparatus of claim 18, wherein the source of power is provided by a device selected from the group consisting of a battery powered electric drill, an electric drill and an electric motor.

20. An apparatus comprising:
a knife, the knife is configured to be rotated by a portable power source;
a blender bottle having an end-cap section and a main compartment, the knife is rotatably coupled with the end-cap section and the knife is substantially contained within the end-cap section, the end-cap section is releasably couple-able with the main compartment, such that food contents can be cut by the knife when the knife is rotated by the portable power source.

21. The apparatus of claim 20, wherein the knife is configured to be detachably coupled with the portable power source.

22. The apparatus of claim 21, wherein the portable power source is selected from the group consisting of a battery powered electric drill, an electric drill and an electric motor.

23. The apparatus of claim 20, wherein the blender bottle has a wall thickness, the wall thickness further comprising:
a first region having a first thermal conductivity; and
a second region having a second thermal conductivity.

24. The apparatus of claim 23, wherein the first region and the second region define a void.

25. The apparatus of claim 23 wherein at least one of the first region and the second region is an insulation layer.

26. The apparatus of claim 23, further comprising:
an advertisement attached to the blender bottle and visible to a viewer.

27. The apparatus of claim 23, wherein the advertisement is selected from the group consisting of a sports team advertisement, a charity advertisement, a business advertisement, an advertisement for a geographic area, an advertisement promoting a cause and a general advertisement.

28. The apparatus of claim 20, wherein a shape of the blender bottle is selected from the group consisting of a cone, a beaker, a football, a golf ball and a user defined shape.

29. The apparatus of claim 20, further comprising:
a drinking lid, the drinking lid is configured to mate with the blender bottle and to facilitate drinking by a user.

30. The apparatus of claim 20, the blender bottle further comprising:
a grip to facilitate grasping the blender bottle.

31. The apparatus of claim 30, wherein the grip is selected from the group consisting of an indentation, a friction layer, an appendage and a handle.

32. The apparatus of claim 20, the blender bottle further comprising:
a first volume, the first volume configured to receive the food contents and to be couple-able with the knife; and
a second volume, the second volume is configured to contain a handle, wherein the food contents are contained within the first volume and the food contents do not enter into the second volume.

33. The apparatus of claim 23, wherein the wall thickness is variable and the second volume defines a portion of an insulation layer within the wall thickness.

34. An apparatus comprising:
a container to receive a quantity of food, the container having a wall thickness, the wall thickness having, a first region, the first region having a first thermal conductivity and a second region, the second region having a second thermal conductivity; and
a knife rotatably couple-able with the container, the knife is configured to be rotated by a portable power source, such that the quantity of food can be cut into smaller pieces.

35. The apparatus of claim 34, wherein the knife is configured to be detachably coupled with the portable power source.

36. The apparatus of claim 35, wherein the portable power source is selected from the group consisting of a battery powered electric drill, an electric drill and an electric motor.

37. The apparatus of claim 34, further comprising:
an advertisement attached to the container, the advertisement is visible to a viewer.

38. The apparatus of claim 37, wherein the advertisement is selected from the group consisting of a sports team advertisement, a charity advertisement, a business advertisement, an advertisement for a geographic area, an advertisement promoting a cause and a general advertisement.

39. The apparatus of claim 34, wherein a shape of the container is selected from the group consisting of a cone, a beaker, a football, a golf ball and a user defined shape.

40. The apparatus of claim 34, further comprising:
a drinking lid, the drinking lid is configured to mate with the container and to facilitate drinking by a user.

41. The apparatus of claim 34, the container further comprising:
a grip to facilitate grasping the container.

42. The apparatus of claim 41, wherein the grip is selected from the group consisting of an indentation, a friction layer, an appendage and a handle.

43. The apparatus of claim 34, the container further comprising:
a first volume, the first volume configured to receive the quantity of food and to be couple-able with the knife; and
a second volume, the second volume is configured to contain a handle, wherein the quantity of food is contained within the first volume and the quantity of food does not enter into the second volume.

44. An apparatus comprising:
a means for containing a quantity of food;
a means for cutting the quantity of food into smaller pieces;
a means for mounting the means for cutting, wherein the means for mounting provides protection for a user from the means for cutting by substantially enclosing the means for cutting.

45. The apparatus of claim 44, further comprising:
a means for advertising, the means for advertising is coupled with the apparatus such that the means for advertising is visible to a user.

46. The apparatus of claim 44, further comprising:
a means for gripping the means for containing.
